(19) United States
(12) Patent Application Publication
(10) Pub. No.: US 2017/0132572 A1
(43) Pub. Date: May 11, 2017

(54) METHOD FOR MANAGING SCHEDULE INFORMATION AND ELECTRONIC DEVICE THEREOF

(71) Applicant: SAMSUNG ELECTRONICS CO., LTD., Suwon-si (KR)

(72) Inventors: Jaeseok JOO, Seongnam-si (KR); Jin-Gil YANG, Suwon-si (KR); Yo-Han LEE, Seongnam-si (KR)

(21) Appl. No.: 15/257,979

(22) Filed: Sep. 7, 2016

(30) Foreign Application Priority Data
Nov. 10, 2015 (KR) 10-2015-0157567

(51) Int. Cl. G06Q 10/10

(52) U.S. Cl. CPC G06Q 10/1093

(57) ABSTRACT

Various example embodiments of the present disclosure relate to an apparatus and a method for an electronic device to manage schedule information. The electronic device includes a display, a communication interface comprising communication circuitry, and a processor, wherein the processor may be configured to: generate a schedule; generate a preferable weather range corresponding to the schedule based on setting information on the schedule; identify weather forecast information corresponding to the schedule; and update the schedule based on a result of comparing the preferable weather range and the weather forecast information. Other example embodiments may be possible.

### CROSS-REFERENCE TO RELATED APPLICATION

This application is based on and claims priority under 35 U.S.C. §119 to Korean Application Serial No. 10-2015-0157567, which was filed in the Korean Intellectual Property Office on Nov. 10, 2015, the content of which is incorporated by reference herein in its entirety.

### TECHNICAL FIELD

Various example embodiments of the present disclosure relate to an apparatus and a method for an electronic device to manage schedule information.

### BACKGROUND

The advancement of info-communications and semiconductor technologies allows a variety of electronic devices to evolve into multimedia devices that provide diverse multimedia services. For example, a portable electronic device is capable of providing various services including a broadcast service, a wireless Internet service, a camera service, and a music player service.

An electronic device may provide a scheduling service to satisfy a variety of user's scheduling needs. For example, when the time for a schedule approaches according to schedule information input by a user, the electronic device may output notification information so that the user is notified of the schedule.

An electronic device may generate at least one piece of schedule information corresponding to user input information when providing a scheduling service. The electronic device may update or rearrange the preset schedule information based on the user input information. That is, the user of the electronic device may be inconvenienced by manually inputting schedule information in order to change a schedule.

### SUMMARY

Various example embodiments of the present disclosure may control an apparatus and a method for an electronic device to automatically update a schedule based on a feature of the schedule information.

Various example embodiments of the present disclosure may control an apparatus and a method for an electronic device to automatically set a feature of schedule information based on schedule setting information.

According to various example embodiments of the present disclosure, an electronic device may include: a display; a communication interface; and a processor, wherein the processor may be configured to: generate a schedule; generate a preferable weather range corresponding to the schedule based on setting information on the schedule; identify weather forecast information corresponding to the schedule; and update the schedule based on a result of comparing the preferable weather range and the weather forecast information.

According to various example embodiments of the present disclosure, an operating method of an electronic device may include: generating a schedule; generating a preferable weather range corresponding to the schedule based on setting information on the schedule; identifying weather forecast information corresponding to the schedule; and updating the schedule based on a result of comparing the preferable weather range and the weather forecast information.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a diagram illustrating an example electronic device in a network environment according to various example embodiments of the present disclosure;

FIG. 2 is a block diagram illustrating an example electronic device according to various example embodiments of the present disclosure;

FIG. 3 is a block diagram illustrating an example program module according to various example embodiments of the present disclosure;

FIG. 4 is a diagram illustrating an example structure for a program module to provide a context-based service according to various example embodiments of the present disclosure;

FIG. 5 is a flowchart illustrating an example where an electronic device updates schedule information according to various example embodiments of the present disclosure;

FIGS. 6A, 6B and 6C are diagrams illustrating example screen configurations for the electronic device to set schedule information according to various example embodiments of the present disclosure;

FIG. 7 is a flowchart illustrating an example where an electronic device sets a schedule according to various example embodiments of the present disclosure;

FIG. 8 is a flowchart illustrating an example where an electronic device sets a weather feature for a schedule based on a parameter for determining a preferable weather range included in schedule information according to various example embodiments of the present disclosure;

FIG. 9 is a flowchart illustrating an example where an electronic device sets a weather feature for a schedule based on weather-related user context according to various example embodiments of the present disclosure;

FIG. 10 is a flowchart illustrating an example where an electronic device sets a weather feature for a schedule based on a weather feature of a counterpart electronic device to share a schedule with according to various example embodiments of the present disclosure;

FIG. 11 is a flowchart illustrating an example where an electronic device detects a weather forecast according to various example embodiments of the present disclosure;

FIG. 12 is a flowchart illustrating an example where an electronic device updates a time or location for a schedule according to various example embodiments of the present disclosure; and

FIGS. 13A and 13B are diagrams illustrating example screen configurations for recommending an alternative time or alternative location on an electronic device according to various example embodiments of the present disclosure.

### DETAILED DESCRIPTION

Hereinafter, various example embodiments of the present disclosure will be described with reference to the accompanying drawings. In the following description, specific details such as detailed configuration and components are merely provided to assist the overall understanding of these example embodiments of the present disclosure. Therefore, it should be apparent to those skilled in the art that various changes and modifications of the example embodiments described herein can be made without departing from the scope and spirit of the present disclosure. In addition, descriptions of well-known functions and constructions may be omitted for clarity and conciseness.

The present disclosure may describe various example embodiments, and modifications and changes may be made therein. Therefore, the present disclosure will be described in detail with reference to particular embodiments illustrated in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various example embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic appcessory, an electronic tattoo, a smart mirror, or a smart watch), or the like.

According to some example embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like.

According to another example embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like.

According to some example embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like. The electronic device according to various example embodiments of the present disclosure may be a combination of one or more of the aforementioned various devices. The electronic device according to some example embodiments of the present disclosure may be a flexible device. Further, the electronic device according to an example embodiment of the present disclosure is not limited to the aforementioned devices, and may include a new electronic device according to the development of technology

Hereinafter, an electronic device according to various example embodiments will be described with reference to the accompanying drawings. As used herein, the term “user” may indicate a person who uses an electronic device or a device (e.g., an artificial intelligence electronic device) that uses an electronic device.

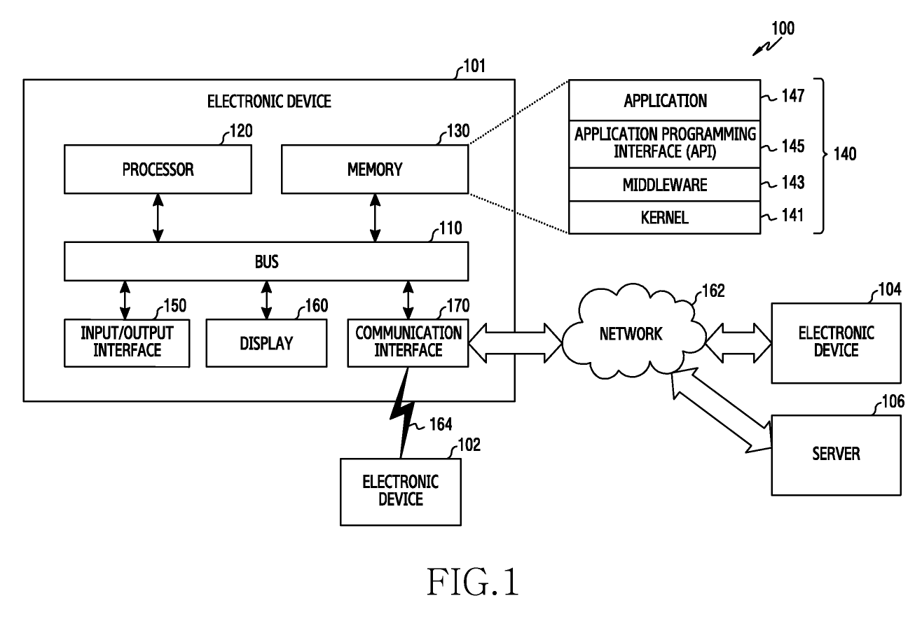

FIG. 1 is a diagram illustrating an example electronic device in a network environment 100 in various example embodiments of the present disclosure.

Referring to FIG. 1, The electronic device 101 may include a bus 110, a processor (e.g., including processing circuitry) 120, a memory 130, an input/output interface (e.g., including input/output circuitry) 150, a display (e.g., including a display panel and display circuitry) 160, and a communication interface (e.g., including communication circuitry) 170. In some embodiments, the electronic device 101 may omit at least one of the above elements or may further include other elements.

The bus 110 may include, for example, a circuit that interconnects the components 120 to 170 and delivers communication (for example, a control message and/or data) between the components 120 to 170.

The processor 120 may include one or more of a Central Processing Unit (CPU), an Application Processor (AP), and a Communication Processor (CP). For example, the processor 120 may carry out operations or data processing relating to control and/or communication of at least one other element of the electronic device 101.

According to one example embodiment, the processor 120 may set a schedule. For example, when the processor 120 detects that a schedule setup event occurs, the processor 120 may control the display 160 to display a schedule setup screen. The processor 120 may generate schedule information including setting information, such as “title,” “location,” and “time,” based on input information corresponding to each field on the schedule setup screen detected through the input/output interface 150. In addition, the processor 120 may generate schedule information that further includes at least one additional piece of information among “transportation” and “importance” based on the input information corresponding to each field on the schedule setup screen detected by the input/output interface 150. For example, the processor 120 may generate schedule information on the electronic device 101 based on schedule-related information received through the communication interface 170.

According to one example embodiment, the processor 120 may set a preferable weather range corresponding to the schedule information. For example, the processor 120 may set a preferable weather range for the schedule in view of a parameter (weather-related parameter, for example, a title, a location, and a transportation) for determining a preferable weather range included in the schedule information. For example, the processor 120 may set the preferable weather range for the schedule by applying different weightings to parameters for determining a preferable weather range. For example, the processor 120 may generate or update the preferable weather range for the schedule in further view of user context related to weather. For example, the processor 120 may update the preferable weather range for the schedule in further view of a preferable weather range for the schedule received from an external electronic device that shares the schedule. For example, the processor 120 may set, as the preferable weather range for the schedule shared with the external electronic device, overlap weather between the preferable weather range determined by the electronic device 101 and the preferable weather range received from the external electronic device. For example, the processor 120 may update the preferable weather range in view of weather setup priorities of electronic devices that share the schedule.

According to one example embodiment, the processor 120 may set the importance of the schedule information. For example, the processor 120 may set the importance of the schedule in view of importance-related parameters (for example, a title, location, and time) included in the schedule information. For example, the processor 120 may set the importance of the schedule by applying different weightings to the importance-related parameters. For example, the processor 120 may set the importance of the schedule based on input information detected by the input/output interface 150.

According to one example embodiment, the processor 120 may monitor a weather forecast for the schedule information (for example, time and location) to automatically update the schedule information. For example, the processor 120 may periodically monitor a weather forecast for the time set for the schedule and the location set for the schedule. When the monitored weather forecast satisfies the preferable weather range for the schedule, the processor 120 may maintain setting information on the schedule. When the monitored weather forecast does not satisfies the preferable weather range for the schedule, the processor 120 may update the schedule. For example, when the monitored weather forecast is out of the preferable weather range for the schedule, the processor 120 may control the display 160 to display alternative information for updating the time or location for the schedule. The processor 120 may selectively update the schedule information based on input information corresponding to the alternative information detected through the input/output interface 150. For example, the alternative information on the schedule may include at least one of an alternative time and an alternative location for the schedule.

According to one example embodiment, the processor 120 may control a weather forecast monitoring period. For example, the processor 120 may set the weather forecast monitoring period based on the importance of the schedule. For example, the processor 120 may set a shorter weather forecast monitoring period as the schedule has higher importance. For example, the processor 120 may set the weather forecast monitoring period based on the sensitivity of the schedule to weather. For example, the sensitivity of a schedule to weather is an index to indicate how much the schedule is influenced by weather, and a schedule that is largely influenced by weather, such as an outdoor activity (for example, a sports day), is determined to have high sensitivity to weather. Accordingly, the processor 120 may set a shorter weather forecast monitoring period for a schedule with higher sensitivity to weather. For example, when the monitored weather forecast does not satisfy the preferable weather range for the schedule, the processor 120 may update the weather forecast monitoring period to become shorter. For example, when the monitored weather forecast satisfies the preferable weather range for the schedule, the processor 120 may update the weather forecast monitoring period to become longer. For example, the processor 120 may update the weather forecast monitoring period to correspond to sensitivity to the monitored weather forecast. For example sensitivity to a weather forecast is an index to indicate a change in forecasted weather, and higher sensitivity may indicate that a more considerable weather change is expected. Accordingly, the processor 120 may update the weather forecast monitoring period to become shorter with higher sensitivity to the weather forecast.

According to one example embodiment, the processor 120 may selectively update the schedule based on the importance of the schedule. For example, the processor 120 may determine that a schedule with higher importance has higher importance in performing the schedule, and thus may set higher freedom of change for the schedule. Accordingly, when the importance of the schedule is “high,” the processor 120 may activate a schedule updating service to update at least one of the time and the location for the schedule. For example, the processor 120 may determine that a schedule with lower importance has lower importance in performing the schedule, and thus may set lower freedom of change for the schedule. Accordingly, when the importance of the schedule is “low,” the processor 120 may deactivate the schedule updating service.

The memory 130 may include a volatile and/or nonvolatile memory. The memory 130 may store, for example, a command or data (for example, reference distance) related to at least one different component of the electronic device 101.

According to one example embodiment, the memory 130 may store information for setting a feature of a schedule. For example, the memory 130 may store a reference keyword table for extracting a parameter for determining a preferable weather range or an importance related parameter from schedule information. For example, the memory 130 may store user context that is created with the electronic device 101 being operated.

According to one example embodiment, the memory 130 may store software and/or a program 140. The program 140 may include, for example, a kernel 141, middleware 143, an application programming interface (API) 145, or an application program (or “application”) 147. At least part of the kernel 141, the middleware 143, and the API 145 may be designated as an operating system (OS).

The input/output interface 150 may include various input/output circuitry to serve as an interface that delivers a command or data, which is input from, for example, a user or different external device, to a different component(s) of the electronic device 101. Further, the input/output interface 150 may output a command or data, which is received from a different component(s) of the electronic device 101, to the user or different external device. According to one example embodiment, the input/output interface 150 may include various input/output circuitry, such as, for example, and without limitation, circuitry configured to receive a touch, gesture, proximity, or hovering inputs using an electronic pen or a user body part.

The display 160 may display, for example, various types of content (for example, a text, an image, a video, an icon, a symbol, or the like) for the user. The display 160 may include, for example, a liquid crystal display (LCD), a light emitting diode (LED) display, an organic light emitting diode (OLED) display, a microelectromechanical systems (MEMS) display, and an electronic paper display.

The communication interface 170 may include various communication circuitry to establish communication, for example, between the electronic device 101 and an external device. For example, the communication interface 170 may be connected to a network 162 via wireless communication or wire-based communication to communicate with an external device (for example, the second external electronic device 104 or the server 106). For example, the communication interface 170 may communicate with an external device (for example, the first external electronic device 102) through a short-range communication 164 or wire-based communication. For example, the first external electronic device 102 may include an electronic device that supports a display function.

The wireless communication may use, for example, a cellular communication protocol, for example, at least one of Long-Term Evolution (LTE), LTE-Advanced (LTE-A), code division multiple access (CDMA), wideband CDMA (WCDMA), universal mobile telecommunications system (UMTS), Wireless Broadband (WiBro), and Global System for Mobile Communications (GSM). Further, the wireless communication may include new communication protocols based on technological advancement, without being limited to the foregoing communication protocols.

Further, the wireless communication may include, for example, the short-range communication 164. The short-range communication 164 may include, various communication circuitry, such as, for example, and without limitation at least one of Wireless Fidelity (Wi-Fi), Bluetooth, Near Field Communication (NFC), and global navigation satellite system (GNSS). The GNSS may include, for example, at least one of a global positioning system (GPS), a global navigation satellite system (Glonass), a Beidou navigation satellite system (hereinafter, “Beidou”), and Galileo depending on a use area or bandwidth. In the present document, “GPS” may be interchangeably used with “GNSS” hereinafter. The wire-based communication may include, for example, at least one of universal serial bus (USB), high definition multimedia interface (HDMI), recommended standard 232 (RS-232), and plain old telephone service (POTS). In addition, the wireless communication may include new short-range communication modes based on technological advancement, without being limited to the foregoing short-range communication modes.

According to one example embodiment, the network 162 may include at least one of a telecommunications network, a computer network (for example, a local area network (LAN) or wide area network (WAN)), the Internet, and a telephone network.

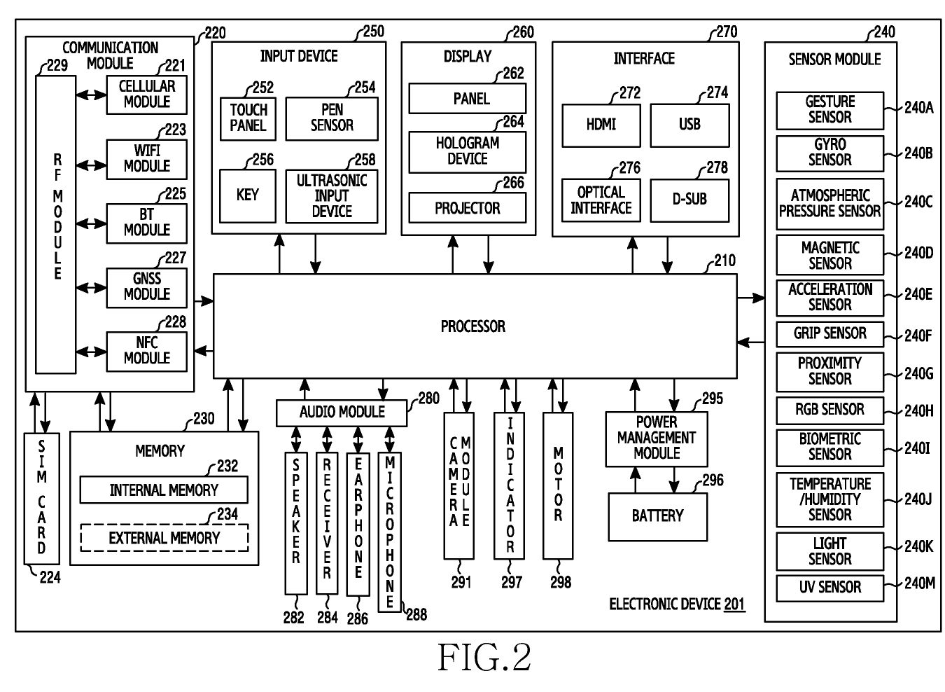

FIG. 2 is a block diagram illustrating an example electronic device 201 according to various example embodiments. The electronic device 201 may include, for example, the whole or part of the electronic device 101 illustrated in FIG. 1. The electronic device 201 may include one or more processors (for example, APs) 210, a communication module (e.g., including communication circuitry) 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processors 210 may run, for example, an OS or an application program to control a plurality of hardware or software components that are connected to the processors 210 and may perform various kinds of data processing and operations. The processors 210 may be configured, for example, as a system on chip (SoC). According to one example embodiment, the processors 210 may further include a graphic processing unit (GPU) and/or an image signal processor. The processors 210 may include at least part (for example, a cellular module 221) of the components illustrated in FIG. 2. The processors 210 may load a command or data received from at least one of other components (for example, a nonvolatile memory) into a volatile memory to process the command or data and may store various kinds of data in the nonvolatile memory. According to one example embodiment, the processors 210 may control to update setting information on a schedule (for example, a period and a place) based on a feature of the schedule (for example, weather).

The communication module 220 may have a configuration that is the same as, or similar to, that of the communication interface 170 in FIG. 1. The communication module 220 may include various communication circuitry, such as, for example, and without limitation, a cellular module 221, a Wi-Fi module 223, a Bluetooth module 225, a global navigation satellite system (GNSS) module 227 (for example, a global positioning system (GPS) module, a Glonass module, a Beidou module, or a Galileo module), a near field communication (NFC) module 228, and a radio frequency (RF) module 229.

The cellular module 221 may provide, for example, an application call, a video call, a text messaging service, or an Internet service through a communication network. According to one example embodiment, the cellular module 221 may perform identification and authentication of the electronic device 201 in a communication network using the SIM (for example, an SIM card) 224. According to one example embodiment, the cellular module 221 may perform at least part of the functions provided by the processors 210. According to one example embodiment, the cellular module 221 may include a communication processor (CP).

The Wi-Fi module 223, the Bluetooth module 225, the GNSS module 227, and the NFC module 228 may each include a processor to process data transmitted and received via the respective modules. According to one example embodiment, at least part (for example, two or more) of the cellular module 221, the Wi-Fi module 223, the Bluetooth module 225, the GNSS module 227, and the NFC module 228 may be included in one integrated chip (IC) or IC package.

The RF module 229 is another example of communication circuitry that may transmit and receive, for example, a communication signal (for example, an RF signal). According to another example embodiment, at least one of the cellular module 221, the Wi-Fi module 223, the Bluetooth module 225, the GNSS module 227, and the NFC module 228 may transmit and receive an RF signal through a separate RF module.

The SIM 224 may include, for example, a card including an SIM and/or an embedded SIM and may include unique identification information (for example, an integrated circuit card identifier (ICCID)) or subscriber information (for example, an international mobile subscriber identity (IMSI)).

The memory 230 (for example, a memory 130) may include, for example, an internal memory 232 or an external memory 234. The external memory 234 may be functionally and/or physically connected to the electronic device 201 through various interfaces.

The sensor module 240 may measure, for example, physical quantities or may detect an operation state of the electronic device 201 and convert measured or detected information into an electrical signal. The sensor module 240 may include, for example, at least one of a gesture sensor 240A, a gyro sensor 240B, a barometric or atmospheric pressure sensor 240C, a magnetic sensor 240D, an accelerometer 240E, a grip sensor 240F, a proximity sensor 240G, a color sensor 240H (for example, a red, green, and blue (RGB) sensor), a biometric sensor 240I, a temperature/humidity sensor 240J, an illumination or light sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit to control at least one or more sensors belonging thereto. In one example embodiment, the electronic device 201 may further include a processor configured, as a part of the processors 210 or separately from the processors 210, to control the sensor module 240, thereby controlling the sensor module 240 while the processors 210 are in a sleep state.

The input device 250 may include various input circuitry, such as, for example, and without limitation a touch panel 252, a (digital) pen sensor 254, a key 256, or an ultrasonic input device 258. The touch panel 252 may use, for example, at least one of an electrostatic type, a pressure-sensitive type, an infrared type, and an ultrasonic type. Further, the touch panel 252 may further include a control circuit. The touch panel 252 may further include a tactile layer to provide a user with a tactile response.

The (digital) pen sensor 254 may, for example, be part of the touch panel or include a separate recognition sheet. The key 256 may include, for example, a physical button, an optical key, or a keypad. The ultrasonic input device 258 may detect ultrasonic waves generated in an input tool through a microphone (for example, a microphone 288) and may identify data corresponding to the detected ultrasonic waves.

The display 260 (for example, a display 160) may include a panel 262, a hologram device 264, or a projector 266. The panel 262 may include a configuration that is the same as, or similar to, that of the display 160 of FIG. 1. The panel 262 may be configured, for example, to be flexible, transparent, or wearable. The panel 262 may be formed with the touch panel 252 in a single module. The hologram device 264 may display a three-dimensional image in the air using the interference of light. The projector 266 may project light onto a screen to display an image. The screen may be disposed, for example, inside or outside the electronic device 201. According to one example embodiment, the display 260 may further include a control circuit to control the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or alternatively, the interface 270 may include, for example, a mobile high-definition link (MHL) interface, an SD card/MMC interface, or an Infrared Data Association (IrDA) interface.

The audio module 280 may reciprocally convert, for example, a sound and an electrical signal. At least some components of the audio module 280 may be included, for example, in an input/output interface 150 illustrated in FIG. 1. The audio module 280 may process sound information input or output, for example, through a speaker 282, a receiver 284, earphones 286, or the microphone 288.

The camera module 291 is a device that takes, for example, a still image and a video. According to one example embodiment, the camera module 291 may include one or more image sensors (for example, a front sensor or a rear sensor), a lens, an image signal processor (ISP), or a flash (for example, an LED, a xenon lamp, or the like).

The power management module 295 may manage, for example, the power of the electronic device 201. According to one example embodiment, the power management module 295 may include a power management integrated circuit (PMIC), a charger integrated circuit (IC), or a battery or fuel gauge.

The battery 296 may include, for example, a rechargeable battery and/or a solar battery. According to one example embodiment, the battery 296 may include a plurality of cells connectable in series or in parallel.

The indicator 297 may display a specific state of the electronic device 201 or a component thereof (for example, the processors 210), for example, a booting state, a message state, or a charging state. The motor 298 may convert an electrical signal into mechanical vibrations and may generate vibrations or a haptic effect.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

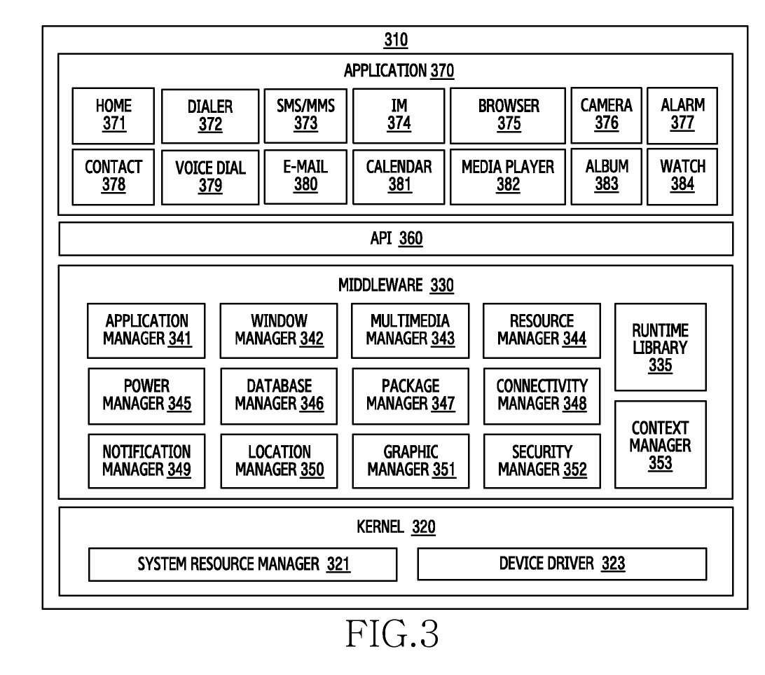

FIG. 3 is a block diagram illustrating an example program module according to various example embodiments. According to one example embodiment, the program module 310 (for example, the program 140) may include an OS that controls resources related to an electronic device (for example, the electronic device 101 or 201) and/or various applications (for example, the application program 147) that run on the OS. The OS may be, for example, Android®, iOS®, Windows®, Symbian®, Tizen®, Bada®, or the like.

The program module 310 may include a kernel 320, middleware 330, an API 360, and/or an application 370. At least part of the program module 310 may be preloaded onto the electronic device or be downloaded from an external device (for example, an external electronic device 102 or 104, a server 106, or the like).

The kernel 320 (for example, the kernel 141) may include, for example, a system resource manager 321 and/or a device driver 323. The system resource manager 321 may perform control, allocation, or recovery of system resources.

The middleware 330 may provide, for example, a function commonly needed for applications 370 or may provide the application 370 with various functions through the API 360 so that the application 370 may efficiently use limited systems resources in the electronic device. According to one example embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and a context manager 353.

The runtime library 355 may include, for example, a library module used by a complier to add a new function through a programming language while the application 370 is running. The runtime library 355 may perform functions for input/output management, memory management, or arithmetic function.

The application manager 341 may manage, for example, the life cycle of at least one application among the applications 370. The window manager 342 may manage graphic user interface (GUI) resources used for a screen. The multimedia manager 343 may identify formats necessary to play various media files and may encode or decode a media file using a codec suitable for a corresponding format. The resource manager 344 may manage resources, such as a source code, a memory, or a storage space, for at least one application among the applications 370.

The power manager 345 may operate with, for example, a basic input/output system (BIOS) to manage a battery or power supply and may provide information on power necessary for an operation of the electronic device. According to one example embodiment, the power manager 345 may control to charge and discharge the battery using at least one of wire-based and wireless methods.

The database manager 346 may generate, retrieve, or change a database to be used for at least one application among the applications 370. The package manager 347 may install or update an application distributed in the form of a package file.

The connectivity manager 348 may manage wireless connectivity, for example, via Wi-Fi or Bluetooth. The notification manager 349 may display or report an incoming message, an appointment, and an event including a proximity notification in a manner that does not disturb a user. The location manager 350 may manage location information on the electronic device. The graphic manager 351 may manage a graphic effect to be provided for the user or a user interface related to the graphic effect. The security manager 352 may provide overall security functions necessary for system security or user authentication.

The context manager 353 may collect log data caused by at least one application 370 running to detect user context. For example, the context manager 353 may include a log manager, a state monitor, and a context analyzer. The log manager may manage log information on the electronic device 101 that is provided from at least one log provider. The state monitor may check a state of a user based on the log information on the electronic device 101 provided from the log manager. The context analyzer may detect a pattern of a user operation based on state information on the user monitored by the state monitor.

According to one example embodiment, when the electronic device (for example, the electronic device 101) has phone features, the middleware 330 may further include a telephony manager to manage an application or video call function of the electronic device.

The middleware 330 may include a middleware module that forms combinations of various functions of the foregoing components. The middleware 330 may provide a specialized module for each type of an OS in order to provide a differentiated function. Further, the middleware 330 may dynamically delete some of the existing components or add new components.

The API 360 (for example, the API 145) is, for example, a set of API programming functions and may be provided with a different configuration depending on an OS. For example, one API set for each platform may be provided in Android or iOS, while two or more API sets for each platform may be provided in Tizen.

The application 370 (for example, the application program 147) may include one or more applications that are capable of performing functions of, for example, a home 371, a dialer 372, an SMS/MMS 373, an instant message (IM) 374, a browser 375, a camera 376, an alarm 377, a contact 378, an application or voice dial 379, an e-mail 380, a calendar 381, a media player 382, an album 383, a clock or watch 384, a health care (for example, for measuring exercising or blood sugar), an environmental data application (for example, for providing atmospheric pressure, humidity, or temperature data), or the like (not shown).

According to one example embodiment, the application 370 may include an application (hereinafter, “information exchange application” for convenience of description) that supports information exchanges between the electronic device (for example, the electronic device 101) and an external electronic device (for example, the electronic device 102 or 104). The information exchange application may include, for example, a notification relay application for relaying specific information to the external electronic device or a device management application for managing the external electronic device.

For example, the notification relay application may include a function of relaying notification information, which is generated in another application (for example, the SMS/MMS application, the email application, the health care application, the environmental data application, or the like) of the electronic device, to the external electronic device (for example, the electronic device 102 or 104). Additionally, the notification relay application may receive notification information, for example, from the external electronic device, and provides the notification information to the user.

The device management application may manage (for example, install, delete, or update), for example, at least one function (for example, a function of turning on/turning off the external electronic device itself (or some components) or adjusting the brightness (or resolution) of a display) of the external electronic device (for example, the electronic device 102 or 104) communicating with the electronic device, an application operating in the external electronic device, or a service (for example, a call service or message service) provided by the external electronic device.

According to one example embodiment, the application 370 may include a third party application that may be downloaded from a preloaded application or the server. The illustrated components of the program module 310, according to the example embodiments, may be named different terms depending on an OS type.

According to various example embodiments, at least part of the program module 310 may be implemented in software, firmware, hardware, or combinations of at least two or more. At least part of the program module 310 may be implemented (for example, run) by, for example, a processor (for example, the processor 210). At least part of the program module 310 may include, for example, a module, a program, a routine, sets of instructions, or a process to perform one or more functions.

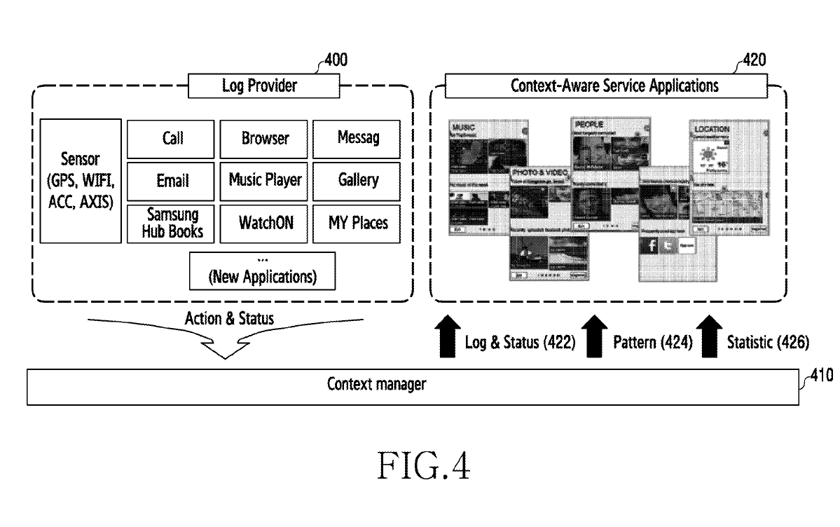

FIG. 4 is a diagram illustrating an example structure for a program module to provide a context-based service according to various example embodiments of the present disclosure.

Referring to FIG. 4, the program module (for example, the program module 310 in FIG. 3) may include a log provider 400, a context manager or context framework 410 (the context manager 353 in FIG. 3), and a context aware service application 420.

According to one example embodiment, the log provider 400 may collect state information resulting from the electronic device 101 operating and may provide the state information to the context manager 410. For example, the state information resulting from the electronic device 101 operating may include communication data, content play data, user biometric data, user exercise data, a purchase history, a search history, state information on the electronic device 101 (for example, an application running history), location data, or the like. For example, the communication data may include data on calls, messages, and e-mails that are transmitted and received via the electronic device 101. The content play data may include a play time, a play period, and a type of content played on the electronic device 101. The user biometric data may include the heartbeat and the blood pressure of a user, which are acquired via at least one sensor. The user exercise data may include the moving distance and the moving speed of the user, which are acquired via at least one sensor.

According to one example embodiment, the log provider 400 may be included in each application, may be configured as an independent application, or may be configured as one manager included in middleware. For example, when the log provider 400 is included in each application, the log provider 400 may collect execution information on the application and may provide the execution information to the context manager 410. For example, when the log provider 400 is configured as one application to collect a log, the log provider 400 may collect execution information on at least one different application or sensor installed in the electronic device 101 and may provide the execution information to the context manager 410. For example, when the log provider 400 is configured as a manager of middleware to collect a log, the log provider 400 may collect execution information on at least one application (for example, the application 370 in FIG. 3) or sensor (for example, the sensor module 240 in FIG. 2) installed in the electronic device 101 and may provide the execution information to the context manager 410.

According to one example embodiment, the context manager 410 may estimate at least one information (for example, context information) among a state 422 of the user (for example, a user of the electronic device 101), an operation pattern 424, and a statistic 426 based on log data provided from at least one log provider 400. For example, the context manager 410 may analyze the log data provided from the at least one log provider 400 and may estimate at least one information among the state 422 of the user (also referred to as “user state”), the operation pattern 424, and the statistic 426 through a log manager, a state monitor, and a context analyzer.

According to one example embodiment, the context manager 410 may transmit at least one information among the user state 422, the operation pattern 424, and the statistic 426 to at least one of the context aware service application 420 and a server (for example, a cloud server). For example, the context manager 410 may transmit at least one information of the user state 422, the operation pattern 424, and the statistic 426 to the server (for example, the cloud server) through a server uploader. In this case, the information transmitted to the server may be used as big data. For instance, the context manager 410 may broadcast at least one information among the user state 422, the operation pattern 424, and the statistic 426. For example, the context manager 410 may transmit, to the context aware service application 420, information corresponding to a request from the context aware service application 420.

According to one example embodiment, the context aware service application 420 may provide a service corresponding to at least one information of the user state 422, the operation pattern 424, and the statistic 426 provided from the context manager 410.

According to various example embodiments of the present disclosure, an electronic device may include: a display; a communication interface; and a processor, wherein the processor may be configured to: generate a schedule; generate a preferable weather range corresponding to the schedule based on setting information on the schedule; identify weather forecast information corresponding to the schedule; and update the schedule based on a result of comparing the preferable weather range and the weather forecast information.

According to various example embodiments, the processor may be configured to extract at least one keyword matching with weather from the setting information on the schedule, and to generate a preferable weather range corresponding to the setting information on the schedule so as to correspond to the at least one keyword.

According to various example embodiments, the processor may be configured to generate or update the preferable weather range corresponding to the setting information on the schedule additionally considering user health information extracted from at least one log data.

According to various example embodiments, the processor may be configured to update the preferable weather range corresponding to the setting information on the schedule in order to correspond to a preferable weather range set in at least one different electronic device that shares the schedule.

According to various example embodiments, the processor may be configured to periodically identify the weather forecast information corresponding to the schedule.

According to various example embodiments, a period for identifying the weather forecast information may be determined based on at least one of importance of the schedule, sensitivity of the schedule to weather, whether a weather forecast satisfies the preferable weather range, and sensitivity of a previously identified weather forecast.

According to various example embodiments, the processor may be configured to set at least one of an alternative time and an alternative location having similar characteristics, in which weather forecast information matching with the preferable weather range is detected, when the preferable weather range is different from the weather forecast information, and to update the schedule based on at least one of the alternative time and the alternative location.

According to various example embodiments, the processor may be configured to selectively update the schedule based on importance of the schedule.

According to various example embodiments, the electronic device may further include an input/output interface, wherein the processor is configured to generate the schedule based on information received through the input/output interface or the communication interface.

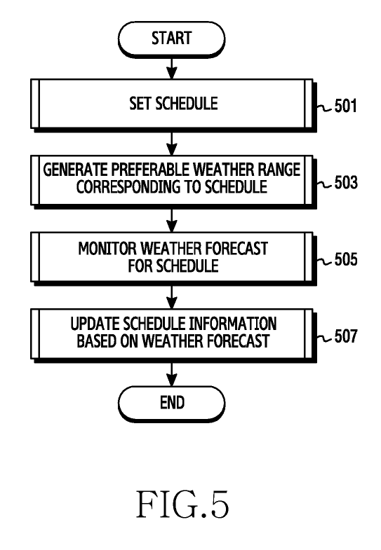

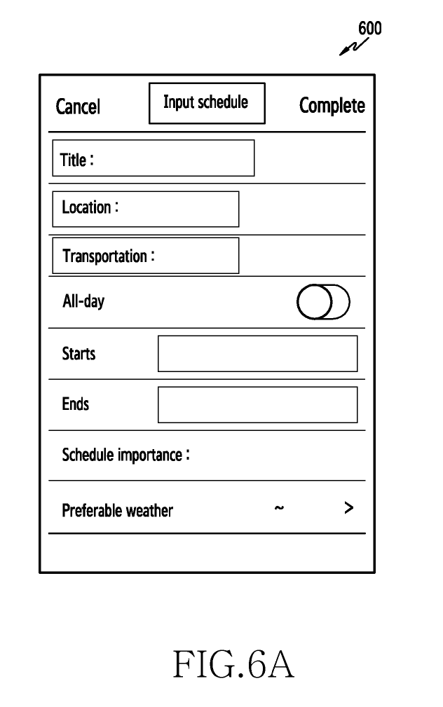

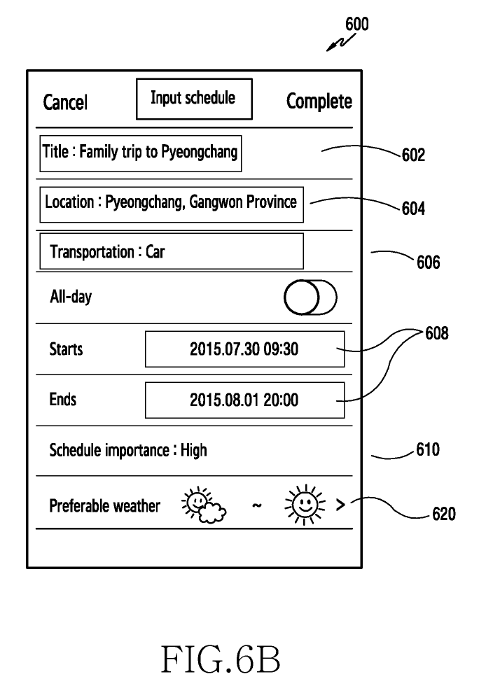

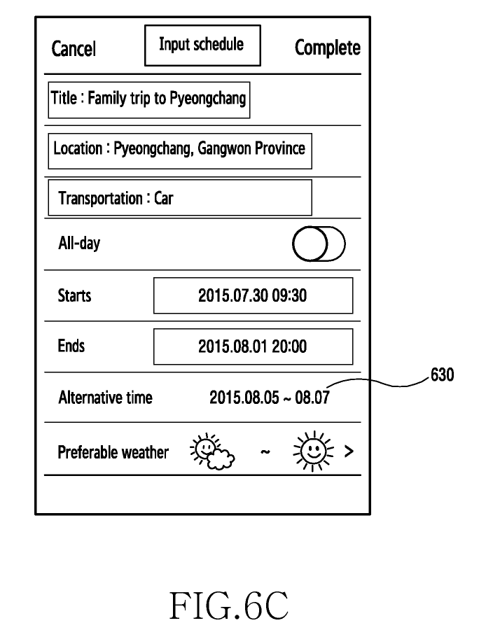

FIG. 5 is a flowchart illustrating an example where an electronic device updates schedule information according to various example embodiments of the present disclosure. FIGS. 6A to 6C are diagrams illustrating an example screen configuration for the electronic device to set schedule information according to various example embodiments of the present disclosure. The following description will be made on an operation of updating schedule information using the screen configuration illustrated in FIGS. 6A to 6C.

Referring to FIG. 5, in operation 501, the electronic device (for example, the electronic device 101 or 201) may set a schedule based on input information detected through an input/output interface (for example, the input/output interface 150). For example, when the processor 120 detects that a schedule setup event occurs, the processor 120 may control the display 160 to display a schedule setup screen 600 in FIG. 6A. For example, the schedule setup event may occur by at least one of schedule setup menu input, schedule setup icon selection, and schedule setup gesture input detection. The processor 120 may generate schedule information based on input information corresponding to the schedule setup screen 600 detected through the input/output interface 150. For example, the processor 120 may generate schedule information using input values of “title,” “location,” “start,” and “end” on the schedule setup screen 600. In addition, the processor 120 may generate schedule information further using at least one of input values of “transportation” and “schedule importance” on the schedule setup screen 600. For example, the processor 120 may recognize an input value of a “location” field using at least one of input address information, selected information from a map image, and geo-fence setting information.

In operation 503, the electronic device may generate a preferable weather range relating to a time and location (place) included in the schedule. For example, the processor 120 may extract a parameter for determining a preferable weather range included in the schedule information. For example, the processor 120 may apply different weightings to input values 602, 604, and 606 of “title,” “location,” and “transportation” fields in FIG. 6B, thereby setting a preferable weather range for the input value 604 of the “location” field (for example, Pyeongchang, Gangwon Province) during a time corresponding to input values 608 of “start” and “end” fields. Additionally or alternatively, the processor 120 may generate or update the preferable weather range for the schedule further in view of user context (for example, user health data) related to weather. Additionally or alternatively, the processor 120 may update the preferable weather range for the schedule in further view of a preferable weather range for the schedule that is determined by an external electronic device that shares the schedule.

In operation 505, the electronic device may monitor a weather forecast for the time for the schedule. For example, the processor 120 may periodically or aperiodically monitor a weather forecast for the time (for example, the input values 608 of the “start” and “end” fields) and location (for example, the input value 604 of “location”) set for the schedule until the schedule starts. Here, a period for monitoring the weather forecast may be set or updated to correspond to the importance 610 of the schedule, the sensitivity of the schedule to weather, and sensitivity to a weather forecast monitored in a previous period.

In operation 507, the electronic device may update the schedule information based on the weather forecast for the time and location set for the schedule. For example, when the weather forecast monitored in operation 505 matches with the preferable weather range 620 corresponding to the schedule generated in operation 503, the processor 120 may maintain the schedule information. For example, when the weather forecast monitored in operation 505 does not match with the preferable weather range 620 corresponding to the schedule generated in operation 503, the processor 120 may output alternative information for the schedule. For example, the processor 120 may detect a different time that satisfies the preferable weather range based on the weather forecast for the location set for the schedule. As illustrated in FIG. 6C, the processor 120 may output the different time that satisfies the preferable weather range as an alternative period (alternative time) 630. For example, the processor 120 may detect a different location that satisfies the preferable weather range based on the weather forecast for the place set for the schedule. The processor 120 may output the different location that satisfies the preferable weather range as an alternative location. For example, the different location may include a different place having similar characteristics to those of the location set for the schedule. The characteristics of the location may include surroundings, building types, or the like.

According to one example embodiment, when the weather forecast for the schedule does not satisfy the preferable weather range 620, the electronic device (for example, the electronic device 101 or 201) may automatically update the schedule using the alternative information. For example, the alternative information may include at least one of an alternative time and an alternative location.

According to one example embodiment, when the weather forecast for the schedule does not satisfy the preferable weather range, the electronic device (for example, the electronic device 101 or 201) may output the alternative information so that the user recognizes the alternative information. When the electronic device detects an input of approving updating of the schedule in response to output of the alternative information, the electronic device may update the schedule using the alternative information. For example, the alternative information may include at least one of an alternative time and an alternative location.

According to one example embodiment, when the weather forecast for the schedule does not satisfy the preferable weather range, the electronic device (for example, the electronic device 101 or 201) may selectively update the schedule using the alternative information to correspond to the importance of the schedule. For example, when the importance of the schedule is relatively high (for example, “high”), the electronic device may update the schedule based on user input information. When the importance of the schedule is relatively low (for example, “medium” or “low”), the electronic device may automatically update the schedule using the alternative information.

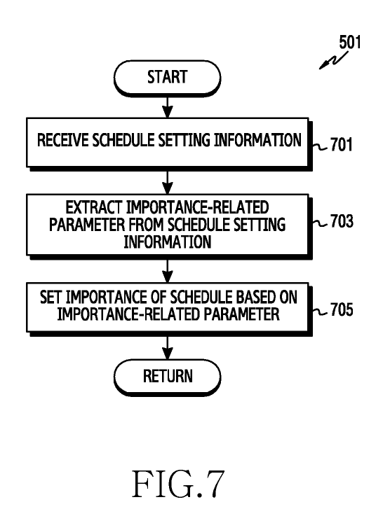

FIG. 7 is a flowchart illustrating an example where the electronic device sets a schedule according to various example embodiments of the present disclosure. The following description will be made on an operation of setting a schedule in operation 501 of FIG. 5.

Referring to FIG. 7, in operation 701, the electronic device (for example, the electronic device 101 or 201) may receive input information for schedule setup. For example, the processor 120 may receive, through the input/output interface 150, at least one of input values of “title,” “location,” “start,” “end,” “transportation,” and “schedule importance” fields for setting a schedule on the schedule setup screen 600 in FIG. 6A. The processor 120 may generate schedule information based on at least one of the input values of the fields included in the schedule setup screen 600. For example, the processor 120 may generate the schedule information on the electronic device 101 based on schedule-related information received through the communication interface 170.

In operation 703, the electronic device may extract an importance-related parameter from the input information for schedule setup received through the input/output interface. For example, the processor 120 may compare a reference keyword table for importance setup stored in the memory 130 with the input information for schedule setup received through the input/output interface, thereby extracting a related parameter (for example, a keyword) for importance setup. For example, the processor 120 may extract parameters of “family,” “company,” “customer,” or the like for setting the importance of the schedule from the input information for schedule setup. The processor 120 may additionally extract, as a parameter for setting the importance of the schedule, schedule setup time information from the input information for schedule setup.

In operation 705, the electronic device may set the importance of the schedule based on the importance-related parameter extracted from the input information for schedule setup. For example, the processor 120 may set the importance of the schedule based on a weighting assigned for the importance-related parameter. For example, the processor 120 may set the highest importance for a schedule including a keyword of “family.” For example, the processor 120 may set the importance of the schedule based on the weighting of the importance-related parameter corresponding to time information included in the schedule. For example, the processor 120 may set the highest importance for a schedule including a keyword of “company” or “customer” in view of a time (general or personal working hours) or location information for the schedule. For example, the processor 120 may set the highest importance for a schedule including a keyword of “family” in view of a time (general or personal out-of-office hours) or location information for the schedule.

According to one example embodiment, the electronic device may generate a schedule including input information for schedule setup and schedule importance information.

According to one example embodiment, the electronic device may generate a schedule based on input information for schedule setup and then may add importance information to the schedule in response to the occurrence of an importance setup event. For example, the importance setup event may occur by at least one of importance setup menu input, importance setup icon selection, and importance setup gesture input detection.

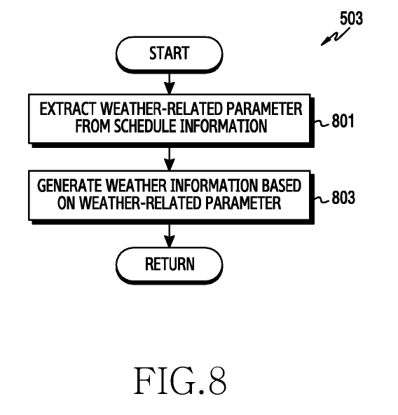

FIG. 8 is a flowchart illustrating an example where the electronic device sets a weather feature for a schedule based on a parameter for determining a preferable weather range included in schedule information according to various example embodiments of the present disclosure. The following description will be made on an operation of generating a preferable weather range for a schedule in operation 503 of FIG. 5.

Referring to FIG. 8, in operation 801, the electronic device (for example, the electronic device 101 or 201) may extract a parameter for determining a preferable weather range from preset schedule information (for example, the schedule set in operation 501 of FIG. 5). For example, the processor 120 may compare a reference keyword table for weather setup stored in the memory 130 with an input value of each field in the schedule, thereby extracting a related parameter (for example, a keyword) for setting a preferable weather range. For example, a “title” field may include a related keyword for weather setup, such as trip, soccer, skiing, sports day, seminar, workshop, or the like. For example, a “location” field may include a related keyword for weather setup, such as stadium, ski resort, mountain, sea, gymnasium, hotel, auditorium, or the like.

In operation 803, the electronic device may generate a preferable weather range for the schedule based on the parameter for determining the preferable weather range extracted from the schedule information. For example, the processor 120 may set a preferable weather range for an outdoor activity or indoor activity through keywords listed in Table 1, which are extracted from input values of the “title” and “location” fields included in the schedule.

TABLE 1

| | Words related to | Words related to |
|---|---|---|
| Classification | “outdoors” | “indoors” |
| Title | Trip, soccer, skiing, sports | Seminar, workshop, etc. |
| | day, etc. | |
| Location | Stadium, ski resort, mountain, | Gymnasium, hotel, |
| | sea, etc. | auditorium, etc. |

For example, the processor 120 may set a preferable weather range for transportation through keywords listed in Table 2, which are extracted from an input value of a “transportation” field included in the schedule.

TABLE 2

| Transportation influenced | Transportation influenced |
|---|---|
| by wind | by snow and fog |
| Ship, airplane | Ship, airplane, car |

For example, the processor 120 may set a preferable weather range by applying different weightings to weather-related parameters (keywords), which are extracted from the input values of the “title,” “location,” and “transportation” fields.

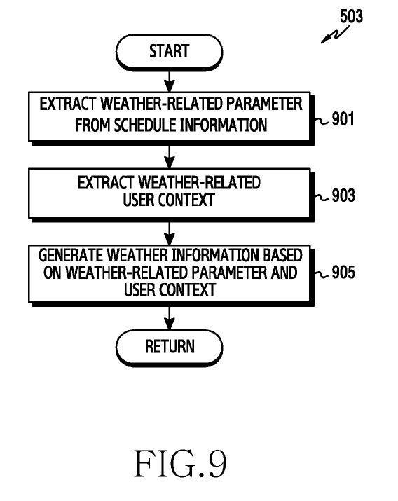

FIG. 9 is a flowchart illustrating an example where the electronic device sets a weather feature for a schedule based on weather-related user context according to various example embodiments of the present disclosure. The following description will be made on an operation of generating a preferable weather range for a schedule in operation 503 of FIG. 5.

Referring to FIG. 9, in operation 901, the electronic device (for example, the electronic device 101 or 201) may extract a parameter for determining a preferable weather range from preset schedule information. For example, the processor 120 may extract a related keyword for preferable weather range setup from the input values of the “title,” “location,” and “transportation” fields of the schedule set in operation 501 of FIG. 5.

In operation 903, the electronic device may analyze application or sensor log data to extract weather-related user context. For example, the processor 120 may analyze log data on user health to extract user health condition information through the context manager 353. For example, the context manager 410 may collect a medical log of the user (for example, a medication record and a medical record), a message log (for example, medical payment information and doctor appointment information), and a search log (for example, a health-related search term) among the log data provided from the at least one log provider 400, and may estimate a health condition of the user (for example, a disease of the user).

In operation 905, the electronic device may generate a preferable weather range (e.g., weather information) for the schedule based on the parameter (keyword) for determining the preferable weather range extracted from the schedule information and the weather-related user context. For example, the processor 120 may set the preferable weather range based on at least one weather-related keyword extracted from the schedule information. The processor 120 may update the preferable weather range to correspond to the weather-related user context. For example, the processor 120 may update the preferable weather range for the schedule by removing weather that influences the disease or illness of the user from the preferable weather range that is generated based on the at least one weather-related keyword extracted from the schedule information. For example, the processor 120 may generate the preferable weather range corresponding to the weather-related user context. The processor 120 may update the preferable weather range based on the at least one weather-related keyword extracted from the schedule information.

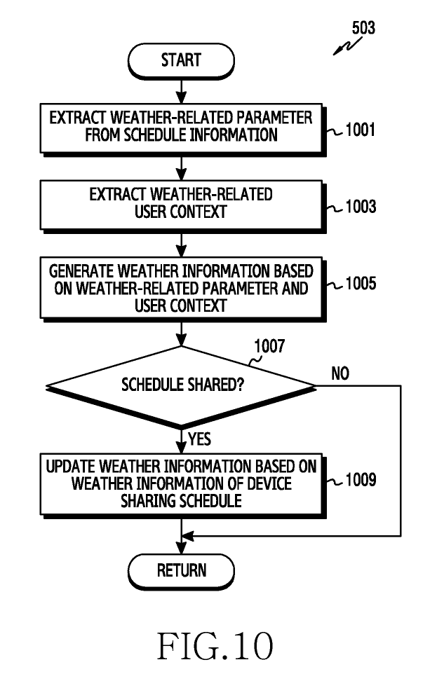

FIG. 10 is a flowchart illustrating an example where the electronic device sets a weather feature for a schedule based on a weather feature of a counterpart electronic device to share the schedule with according to various example embodiments of the present disclosure. The following description will be made on an operation of generating a preferable weather range for a schedule in operation 503 of FIG. 5.

Referring to FIG. 10, in operation 1001, the electronic device (for example, the electronic device 101 or 201) may extract a parameter for determining a preferable weather range from the schedule information set in operation 501 of FIG. 5. For example, the processor 120 may extract at least one related keyword (for example, trip, workshop, car, or the like) for weather setup from the input values of the schedule set in FIG. 6B.

In operation 1003, the electronic device may analyze log data to extract weather-related user context. For example, the processor 120 may extract log data on user health from the log data provided from the at least one log provider 400, and may estimate a disease or illness of the user.

In operation 1005, the electronic device may generate a preferable weather range (e.g., weather information) for the schedule based on the parameter (keyword) for determining the preferable weather range extracted from the schedule information and the weather-related user context. For example, the processor 120 may update the preferable weather range set based on at least one weather-related keyword extracted from the schedule information to correspond to the weather-related user context. For example, the processor 120 may update the set preferable weather range corresponding to the weather-related user context based on at least one weather-related keyword extracted from the schedule information.

In operation 1007, the electronic device may identify whether the schedule is shared with at least one different electronic device. For example, the processor 120 may identify whether there is at least one different electronic device that shares the schedule set in operation 501 of FIG. 5.

In operation 1009, when the schedule is shared with at least one different electronic device, the electronic device may update the preferable weather range for the schedule based on a preferable weather range received from the different electronic device that shares the schedule. For example, the processor 120 may update the preferable weather range for the schedule to overlap weather information between the preferable weather range set in operation 1005 and the preferable weather range received from the different electronic device that shares the schedule. For example, the processor 120 may determine the preferable weather range for the schedule by applying different weightings to the preferable weather range set in operation 1005 and the preferable weather range received from the different electronic device that shares the schedule.

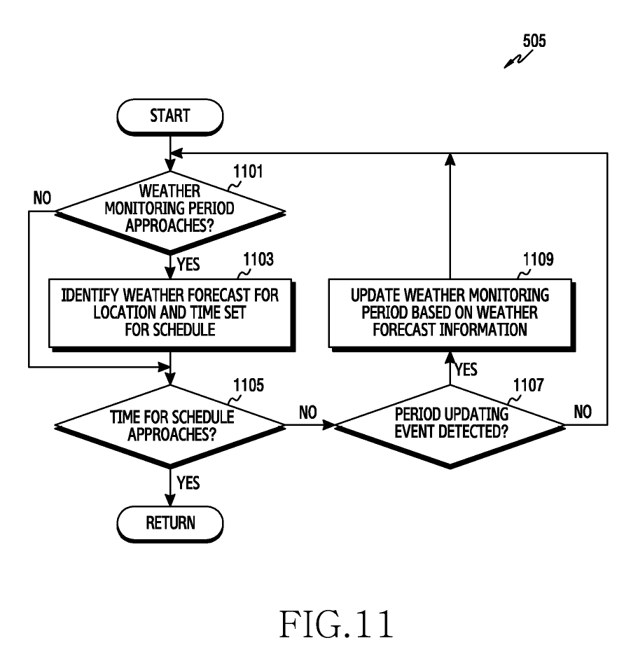

FIG. 11 is a flowchart illustrating an example where the electronic device detects a weather forecast according to various example embodiments of the present disclosure. The following description will be made on an operation of monitoring a weather forecast in operation 505 of FIG. 5.

Referring to FIG. 11, in operation 1101, the electronic device (for example, the electronic device 101 or 201) may determine whether a weather monitoring period approaches. For example, the processor 120 may determine whether a weather monitoring period set based on importance of a schedule approaches. For example, the weather monitoring period may be set to be shorter as the schedule has higher importance.

In operation 1103, when the weather monitoring period approaches, the electronic device may identify a weather forecast for a location set for the schedule during a time set for the schedule. For example, the processor 120 may request and receive the weather forecast for the location and time set for the schedule from a weather server using a scheduling application (for example, a calendar application) that manages schedule information. For example, the processor 120 may request and receive the weather forecast for the location and time set for the schedule from the weather server using a weather application. For example, the weather application may receive, from the weather server, the weather forecast for the location and time set for the schedule provided from the scheduling application (for example, the calendar application).

In operation 1105, the electronic device may determine whether a schedule time approaches. For example, the processor 120 may determine whether an input time of the “start” field in the schedule set through the schedule setup screen 600 of FIG. 6A approaches.

In operation 1107, when the schedule period has not approached, the electronic device may determine whether a period updating event is detected. For example, the processor 120 may determine whether the period updating event occurs based on sensitivity to the weather forecast identified in operation 1103. For example, when a weather forecast of a significant weather change in a short time, such as a typhoon, is detected, the processor 120 determines that sensitivity to the weather forecast is high. The processor 120 may determine that the period updating event occurs.

When the period updating event is not detected, the electronic device may determine whether the preset weather monitoring period approaches in operation 1101.

In operation 1109, when the period updating event is detected, the electronic device may update the weather monitoring period based on weather forecast information. For example, when a weather forecast of a significant weather change in a short time, such as a typhoon, is detected, the processor 120 may update the weather monitoring period to be relatively shorter in order to detect a weather change. For example, when the weather forecast of a significant weather change in a short time, such as typhoon, is lifted, the processor 120 may update the weather monitoring period to be relatively longer in order to detect a weather change.

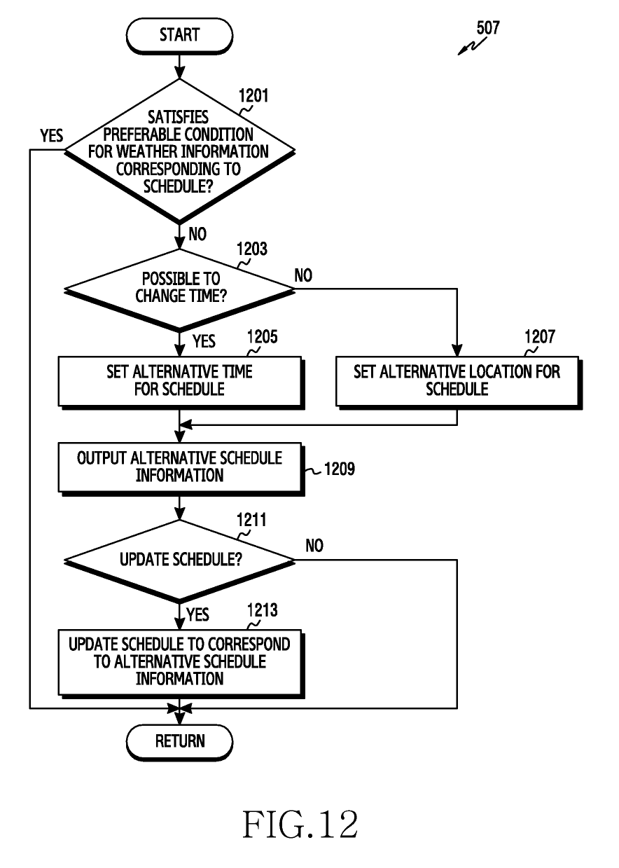

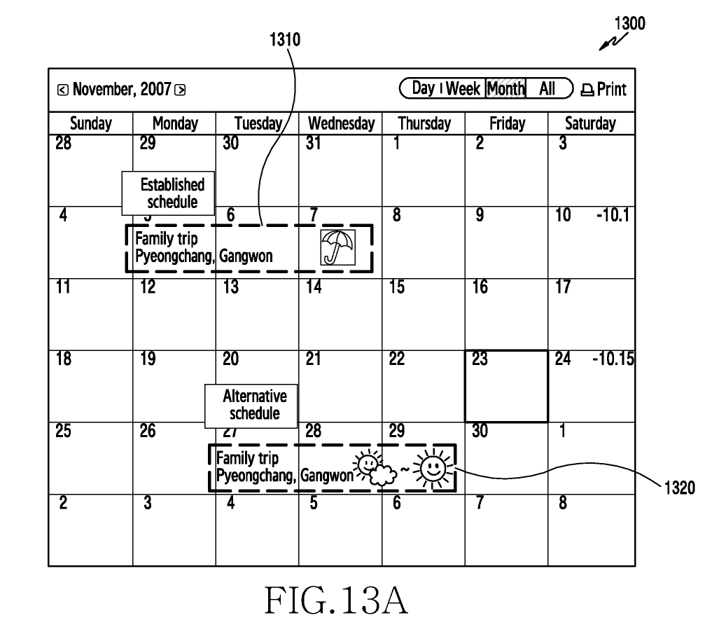

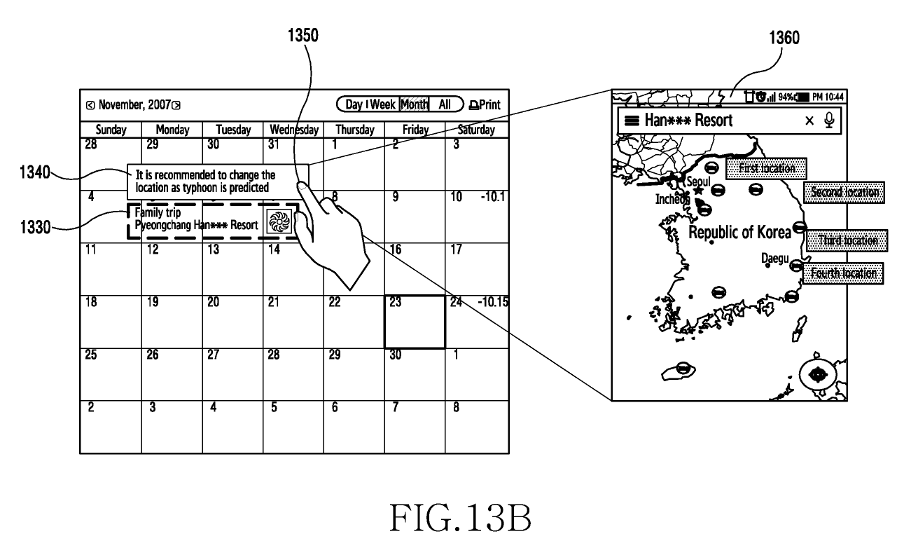

FIG. 12 is a flowchart illustrating an example where the electronic device updates a time or location for a schedule according to various example embodiments of the present disclosure. FIGS. 13A and 13B illustrate a screen configuration for recommending an alternative time or alternative location on the electronic device according to various example embodiments of the present disclosure. The following description will be made on an operation of updating schedule information in operation 507 of FIG. 5 using the screen configuration in FIGS. 13A and 13B.

Referring to FIG. 12, in operation 1201, the electronic device (for example, the electronic device 101 or 201) may determine whether a periodically detected weather forecast satisfies a preferable condition for weather information corresponding to a schedule. For example, the processor 120 may determine whether the preferable weather range for the schedule generated in operation 503 of FIG. 5 matches with the weather forecast for the time and location for the schedule detected in operation 505 of FIG. 5. For example, the processor 120 may determine whether the weather forecast for the time and location for the schedule detected in operation 505 of FIG. 5 is included in the preferable weather range for the schedule generated in operation 503 of FIG. 5.

When the weather forecast satisfies the preferable condition for the weather information corresponding to the schedule, the electronic device may maintain schedule information. In this case, the electronic device may determine again whether the weather monitoring period approaches in operation 1101 of FIG. 11.

In operation 1203, when the weather forecast does not satisfy the preferable condition for the weather information corresponding to the schedule, the electronic device may determine whether it is possible to change the time for the schedule. For example, the processor 120 may determine whether it is possible to change the time for the schedule based on importance of the schedule. For example, the processor 120 may determine whether it is possible to change the time for the schedule based on additional setting information that indicates whether it is possible to change the time for the schedule.

In operation 1205, when it is possible to change the time for the schedule, the electronic device may set an alternative time that satisfies the preferable weather range based on a weather forecast for the location set for the schedule during a time that is different from the time set for the schedule. For example, the processor 120 may set, as the alternative time, a different time that satisfies the preferable weather range for the schedule in the location set for the schedule and is closest to the time set for the schedule. Additionally or alternatively, the processor 120 may set an alternative time further in view of user's another schedule information.

In operation 1207, when it is impossible to change the time for the schedule, the electronic device may set an alternative location that satisfies the preferable weather range based on a weather forecast for a different location set from the location set for the schedule. For example, the processor 120 may set, as the alternative location, a different location that satisfies the preferable weather range during the time set for the schedule and is closest to the location set for the schedule. Additionally or alternatively, the processor 120 may set an alternative location in further view of a location set for the schedule among other locations that satisfy the preferable weather range and information on surroundings.

In operation 1209, the electronic device may display alternative schedule information (for example, the alternative time or alternative location) on a display (for example, the display 160). For example, when the alternative time is set in operation 1205, the processor 120 may control the display 160 to display a calendar image 1300 including schedule information 1310 and 1320 of the time and the alternative time set for the schedule as illustrated in FIG. 13A. For example, when the alternative location is set in operation 1207, the processor 120 may control the display 160 to display a calendar image 1300 including schedule information 1330 and an alternative location providing message 1340 as illustrated in FIG. 13B. When the processor 120 detects that the alternative location providing message 1340 is selected 1350, the processor 120 may display an alternative location using a map image 1360. For example, the alternative location providing message 1340 may be displayed in the form of an icon.

In operation 1211, the electronic device may determine whether to update the schedule information to correspond to the alternative schedule information. For example, the processor 120 may determine, based on the importance of the schedule, whether to update the schedule information to correspond to the alternative schedule information. For example, when the importance of the schedule is relatively high, the processor 120 may determine to update the schedule information to correspond to the alternative schedule information. For example, the processor 120 may determine, based on input information corresponding to the alternative schedule information displayed on the display 160, whether to update the schedule information to correspond to the alternative schedule information. For example, when an input of requesting updating of the schedule information is detected, the processor 120 may determine to update the schedule information to correspond to the alternative schedule information.

When it is determined not to update the schedule information, the electronic device may maintain the schedule information.

In operation 1213, when it is determined to update the schedule information, the electronic device may update the schedule information to correspond to the alternative schedule information. For example, referring to FIG. 13A, the processor 120 may update input values set in “start” and “end” fields of the schedule to correspond to the alternative time 1320. For example, referring to FIG. 13B, the processor 120 may update an input value of a “location” field included in the schedule to any one alternative location selected by the user among a plurality of alternative locations displayed on the map image 1360.

According to one example embodiment, the electronic device may update a schedule preferentially considering whether it is possible to change a location set for the schedule. For example, when it is impossible to change the location for the schedule, the processor 120 may set an alternative time for the schedule.

According to one example embodiment, when a periodically detected weather forecast does not satisfy a preferable condition for weather information corresponding to a schedule, the electronic device may automatically update schedule information to at least one of an alternative time and an alternative location.

According to one example embodiment, when a difference between a current time and a time set for a schedule is less than a reference period of time, the electronic device may update the schedule to correspond to weather forecast information. For example, when an input time set in a “start” field of the schedule is two months away, the processor 120 may limit the updating of the schedule.

According to one example embodiment, the electronic device may selectively set whether to monitor a weather forecast based on a difference between a current time and a time set for a schedule. For example, when an input time set in a “start” field of the schedule is two months away, the processor 120 may limits monitoring of the weather forecast. For example, when the input time set in the “start” field of the schedule is within two months, the processor 120 may monitor a weather forecast for a location and time set for the schedule according to a weather forecast monitoring period.

According to various example embodiments of the present disclosure, an operating method of an electronic device may include: generating a schedule; generating a preferable weather range corresponding to the schedule based on setting information on the schedule; identifying weather forecast information corresponding to the schedule; and updating the schedule based on a result of comparing the preferable weather range and the weather forecast information.

According to various example embodiments, the generating of the preferable weather range may include: extracting at least one keyword matching with weather from the setting information on the schedule; and generating a preferable weather range corresponding to the setting information on the schedule so as to correspond to the at least one keyword.

According to various example embodiments, the method may further include updating the preferable weather range corresponding to the setting information on the schedule in order to correspond to user health information extracted from at least one log data.

According to various example embodiments, the method may further include updating the preferable weather range corresponding to the setting information on the schedule in order to correspond to a preferable weather range set in at least one different electronic device that shares the schedule.

According to various example embodiments, the identifying of the weather forecast information may include periodically identifying the weather forecast information corresponding to the schedule.

According to various example embodiments, a period for identifying the weather forecast information may be determined based on at least one of importance of the schedule, sensitivity of the schedule to weather, whether a weather forecast satisfies the preferable weather range, and sensitivity of a previously identified weather forecast.

According to various example embodiments, the updating of the schedule may include: setting at least one of an alternative time and an alternative location having similar characteristics, in which weather forecast information matching with the preferable weather range is detected, when the preferable weather range is different from the weather forecast information; and updating the schedule based on at least one of the alternative time and the alternative location.

According to various example embodiments, the updating of the schedule may include: determining whether to update the schedule based on importance of the schedule; and updating the schedule based on the result of comparing the preferable weather range and the weather forecast information when it is determined to update the schedule.

According to various example embodiments, the generating of the schedule may include generating the schedule based on information received through an input/output interface or a communication interface of the electronic device.

An electronic device and an operating method thereof, according to various example embodiments, may automatically update setting information on a schedule based on a feature (for example, weather) of schedule information set based on schedule setting information, thereby managing the schedule information to correspond to a user's intention without additional input by the user.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a program module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (for example, a magnetic tape), optical media (for example, a Compact Disc Read Only Memory (CD-ROM) and a Digital Versatile Disc (DVD)), magneto-optical media (for example, a floptical disk), a hardware device (for example, a Read Only Memory (ROM), a Random Access Memory (RAM), a flash memory), and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

The embodiments disclosed herein are provided merely to easily describe technical details of the present disclosure and to help the understanding of the present disclosure, and are not intended to limit the scope of various embodiments of the present disclosure. Therefore, it should be construed that all modifications and changes or various other embodiments based on the technical idea of various embodiments of the present disclosure fall within the scope of various embodiments of the present disclosure.

What is claimed is:

1. An electronic device comprising:
a display;
a communication interface; and
a processor,
wherein the processor is configured to: detect a schedule; detect a preferable weather range corresponding to the schedule based on setting information on the schedule; identify weather forecast information corresponding to the schedule; and update the schedule based on a result of comparing the preferable weather range and the weather forecast information.

2. The electronic device of claim 1, wherein the processor is configured to extract at least one keyword matching with weather from the setting information on the schedule, and to generate a preferable weather range corresponding to the setting information on the schedule to correspond to the at least one keyword.

3. The electronic device of claim 2, wherein the processor is configured to generate or update the preferable weather range corresponding to the setting information on the schedule taking into account user health information extracted from at least one log data.

4. The electronic device of claim 3, wherein the processor is configured to update the preferable weather range corresponding to the setting information on the schedule to correspond to a preferable weather range set in at least one different electronic device that shares the schedule.

5. The electronic device of claim 1, wherein the processor is configured to periodically identify the weather forecast information corresponding to the schedule.

6. The electronic device of claim 5, wherein a period for identifying the weather forecast information is determined based on at least one of an importance of the schedule, a sensitivity of the schedule to weather, whether a weather forecast satisfies the preferable weather range, and a sensitivity of a previously identified weather forecast.

7. The electronic device of claim 1, wherein the processor is configured to set at least one of an alternative time and an alternative location having similar characteristics, in which weather forecast information matching with the preferable weather range is detected, when the preferable weather range is different from the weather forecast information, and to update the schedule based on at least one of the alternative time and the alternative location.

8. The electronic device of claim 1, wherein the processor is configured to selectively update the schedule based on an importance of the schedule.

9. The electronic device of claim 1, further comprising an input/output interface,
wherein the processor is configured to generate the schedule based on information received through the input/output interface or the communication interface.

10. A method of operating an electronic device, the method comprising:
detecting a schedule;
detecting a preferable weather range corresponding to the schedule based on setting information on the schedule;
identifying weather forecast information corresponding to the schedule; and
updating the schedule based on a result of comparing the preferable weather range and the weather forecast information.

11. The method of claim 10, wherein the generating of the preferable weather range comprises: extracting at least one keyword matching with weather from the setting information on the schedule; and generating a preferable weather range corresponding to the setting information on the schedule to correspond to the at least one keyword.

12. The method of claim 11, further comprising updating the preferable weather range corresponding to the setting information on the schedule to correspond to user health information extracted from at least one log data.

13. The method of claim 12, further comprising updating the preferable weather range corresponding to the setting information on the schedule to correspond to a preferable weather range set in at least one different electronic device that shares the schedule.

14. The method of claim 10, wherein the identifying of the weather forecast information comprises periodically identifying the weather forecast information corresponding to the schedule.

15. The method of claim 14, wherein a period for identifying the weather forecast information is determined based on at least one of an importance of the schedule, a sensitivity of the schedule to weather, whether a weather forecast satisfies the preferable weather range, and a sensitivity of a previously identified weather forecast.

16. The method of claim 10, wherein the updating of the schedule comprises: setting at least one of an alternative time and an alternative location having similar characteristics, in which weather forecast information matching with the preferable weather range is detected, when the preferable weather range is different from the weather forecast information; and updating the schedule based on at least one of the alternative time and the alternative location.

17. The method of claim 10, wherein the updating of the schedule comprises: determining whether to update the schedule based on an importance of the schedule; and updating the schedule based on the result of comparing the preferable weather range and the weather forecast information when it is determined to update the schedule.

18. The method of claim 10, wherein the generating of the schedule comprises generating the schedule based on information received through an input/output interface or a communication interface of the electronic device.
